(19) United States
(12) Patent Application Publication
(10) Pub. No.: US 2021/0136148 A1
(43) Pub. Date: May 6, 2021

(54) SYSTEMS FOR CONSISTENT REMOTE DATA REPLICATION AT EXTENDED DISTANCES

(71) Applicant: EMC IP Holding Company LLC, Hopkinton, MA (US)

(72) Inventors: Kevin Heasley, Apple Valley, CA (US); Elizabeth Cecilia Patapoutian, Hopkinton, MA (US); Carol Susan Saparnis, Southborough, MA (US)

(21) Appl. No.: 16/672,326

(22) Filed: Nov. 1, 2019

(51) Int. Cl. H04L 29/08

(52) U.S. Cl. CPC H04L 67/1095; H04L 67/1097

(57) ABSTRACT

Systems for consistent remote data replication at extended distances. Specifically, the disclosed systems outline configurations for implementing two site mirroring, three site single-target mirroring, and three site multi-target mirroring.

### BACKGROUND

Data mirroring (or replication) refers to the sharing of information so as to ensure consistency between redundant sources, such as storage arrays, which may serve to provide data fault-tolerance and/or high availability.

### SUMMARY

In general, in one aspect, the invention relates to a system for two-site mirroring. The system includes a first site including a first storage device, and a second site including a second storage device operatively connected to the first storage device through a first link, and a third storage device operatively connected to the second storage device through a second link.

In general, in one aspect, the invention relates to a system for three-site single-target mirroring. The system includes a first site including a first storage device, a second site including a second storage device operatively connected to the first storage device through a first link, and a third site including a third storage device operatively connected to the second storage device through a second link, and a fourth storage device operatively connected to the third storage device through a third link.

In general, in one aspect, the invention relates to a system for two-site multi-target mirroring. The system includes a first site including a first storage device, a second site including a second storage device operatively connected to the first storage device through a first link, and a third site including a third storage device operatively connected to the first storage device through a second link, and a fourth storage device operatively connected to the third storage device through a third link.

Other aspects of the invention will be apparent from the following description and the appended claims.

### BRIEF DESCRIPTION OF DRAWINGS

FIG. 1A shows a system in accordance with one or more embodiments of the invention.

FIG. 1B shows a two-site mirroring configuration in accordance with one or more embodiments of the invention.

FIG. 1C shows a three-site single-target mirroring configuration in accordance with one or more embodiments of the invention.

FIG. 1D shows a three-site multi-target mirroring configuration in accordance with one or more embodiments of the invention.

FIG. 2 shows an exemplary computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

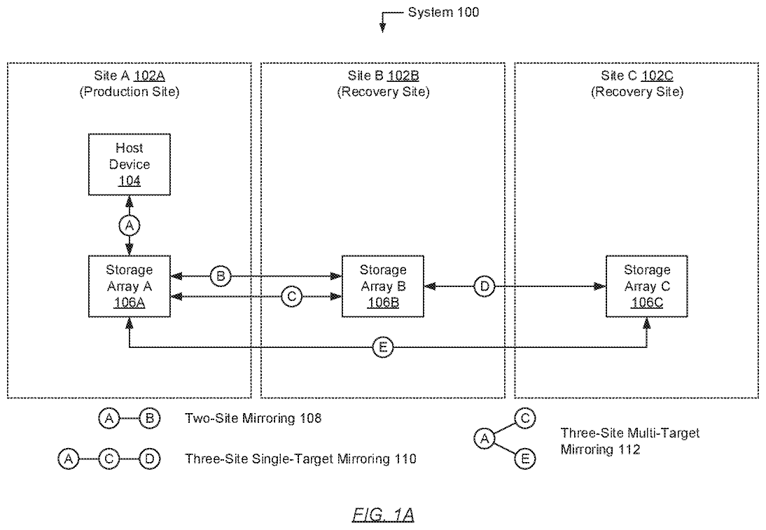

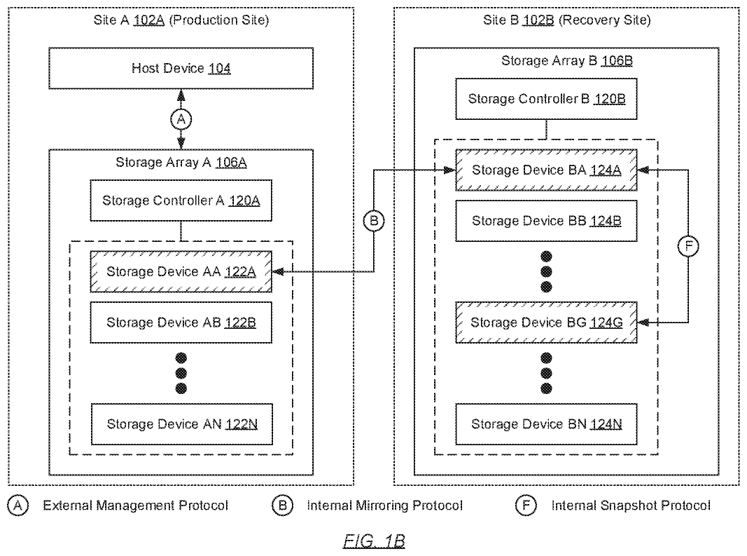

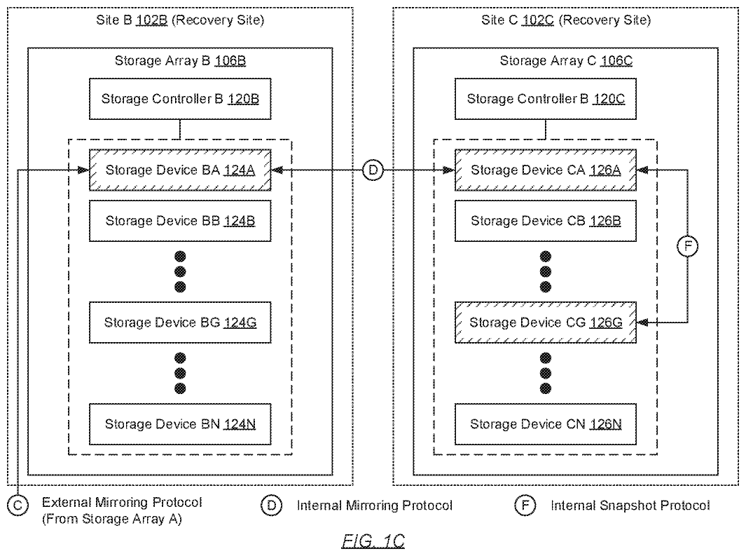

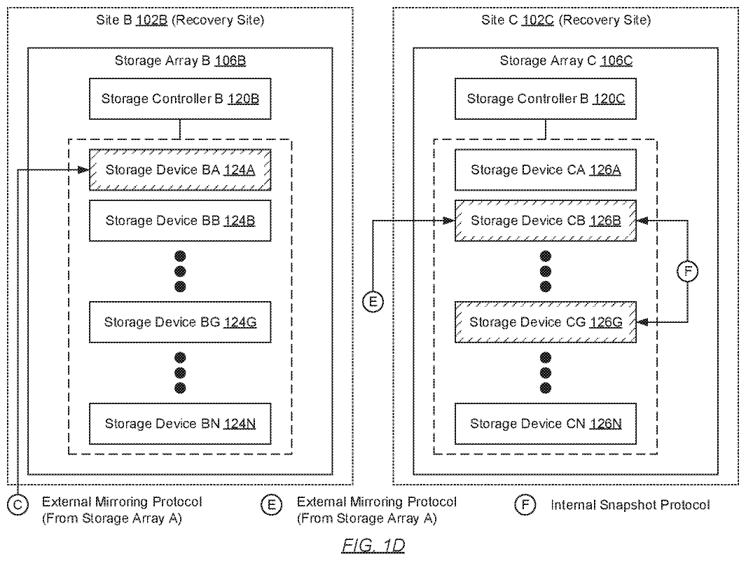

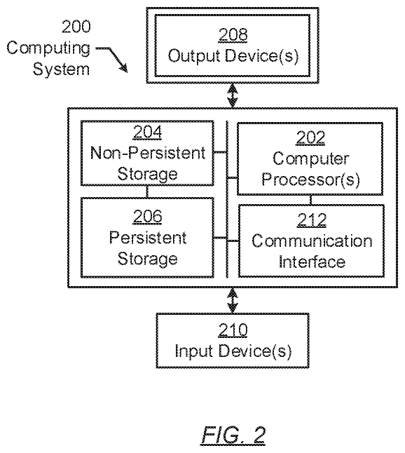

In the following description of FIGS. 1A-2, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to systems for consistent remote data replication at extended distances. Specifically, one or more embodiments of the invention outlines configurations for implementing two site mirroring, three site single-target mirroring, and three site multi-target mirroring.

FIG. 1A shows a system in accordance with one or more embodiments of the invention. The system (100) may include two or three sites (102A, 102B, 102C). Each site (102A, 102B, 102C) may represent a datacenter (i.e., a collection of information technology components) residing in a separate spatial and/or geographical location, which may be spatially and/or geographical distant from the other site in a two-site configuration, or from both other sites in a three-site configuration. The first site (102A) may also be referred to as a production site or datacenter, whereas the second and third sites (102B, 102C) may each also be referred to as a recovery site or datacenter. Furthermore, any configuration of the system (100) may include a host device (104) and two or three storage arrays (106A-106C). Each of these system (100) components is described below.

In one embodiment of the invention, the above-mentioned system (100) components may operatively connect to one another through a network (not shown) (e.g., a local area network (LAN), a wide area network (WAN) such as the Internet, a mobile network, any other network type, or a combination thereof). The network may be implemented using any combination of wired and/or wireless connections. Further, the network may encompass various interconnected, network-enabled components (e.g., switches, routers, gateways, etc.) that may facilitate communications between the above-mentioned system (100) components. Moreover, the above-mentioned system (100) components may communicate with one another using any combination of wired and/or wireless communication protocols.

In one embodiment of the invention, the host device (104) may represent any physical computing system capable of receiving, generating, processing, storing, and/or transmitting data, as well as to provide an environment in which one or more computer programs (not shown) may execute thereon. The computer program(s) may, for example, implement large-scale and complex data processing; or implement one or more services offered locally or over the network. Further, in providing an execution environment for the computer program(s) installed thereon, the host device (104) may include and allocate various resources (e.g., computer processors, memory, storage, virtualization, network bandwidth, etc.), as needed, to the computer program(s) and the task(s) (process(es)) instantiated thereby. One of ordinary skill will appreciate that the host device (104) may perform other functionalities without departing from the scope of the invention. Examples of the host device (104) may include, but are not limited to, a desktop computer, a workstation computer, a server, a mainframe, or any other computing system similar to the exemplary computing system shown in FIG. 2.

In one embodiment of the invention, a storage array (106A-106C) may represent a managed production or recovery storage system for storing production (i.e., original) or recovery (i.e., replicated) data copies, respectively. Furthermore, a storage array (106A-106C) may be implemented using one or more storage servers (not shown). Each storage server may reflect a physical storage server that may reside in a datacenter, or a virtual storage server that may reside in a cloud computing environment. Additionally or alternatively, a storage array (106A-106C) may be implemented using one or more computing systems similar to the exemplary computing system shown in FIG. 2.

In one embodiment of the invention, the above-mentioned system (100) components may work in concert to implement a data mirroring or replication system. Data mirroring or replication may refer to the sharing of information so as to ensure consistency between redundant sources (e.g., storage arrays (106A-106C)), which may serve to provide data fault-tolerance and/or high availability. Further, the data mirroring or replication system may be implemented by way of multiple configurations. Of these configurations, three non-limiting examples—a two-site mirroring configuration (108), a three-site single-target mirroring configuration (110), and a three-site multi-target mirroring configuration (112)—are briefly outlined below.

Two-Site Mirroring Configuration

In one embodiment of the invention, the two-site mirroring configuration (108) may include, but is not limited to: (a) the host device (104); (b) the first (or production) storage array (106A); and (c) the second (or first recovery) storage array (106B). The host device (104) and the first storage array (106A) may reside within the first (or production) site (102A), whereas the second storage array (106B) may reside within the second (or first recovery) site (102B).

Furthermore, in one embodiment of the invention, the host device (104) may operatively connect to the first storage array (106A) through a first (or intra-site) link (A). Meanwhile, the first storage array (106A) may operatively connect to the second storage array (106B) through a second (or first inter-site) link (B). By way of example, the first and second links (A, B) may, at least in part, be implemented using a fibre-channel connection (FICON) fabric, or any other medium that facilitates data transfer. The two-site mirroring configuration (108) is described in further detail below with respect to FIG. 1B.

Three-Site Single-Target Mirroring Configuration

In one embodiment of the invention, the three-site single-target mirroring configuration (110) may include, but is not limited to: (a) the host device (104); (b) the first (or production) storage array (106A); (c) the second (or first recovery) storage array (106B); and (d) the third (or second recovery) storage array (106C). The host device (104) and the first storage array (106A) may reside within the first (or production) site (102A), whereas the second storage array (106B) may reside within the second (or first recovery) site (102B), while the third storage array (106C) may reside within the third (or second recovery) site (102C).

Furthermore, in one embodiment of the invention, the host device (104) may operatively connect to the first storage array (106A) through the first (or intra-site) link (A). The first storage array (106A) may operatively connect to the second storage array (106B) through a third (or second inter-site) link (C). Meanwhile, the second storage array (106B) may operatively connect to the third storage array (106C) through a fourth (or third inter-site) link (D). By way of example, the first, third, and fourth links (A, C, D) may, at least in part, be implemented using a fibre-channel connection (FICON) fabric, or any other medium that facilitates data transfer. The three-site single-target mirroring configuration (110) is described in further detail below with respect to FIG. 1C.

Three-Site Multi-Target Mirroring Configuration

In one embodiment of the invention, the three-site multi-target mirroring configuration (112) may include, but is not limited to: (a) the host device (104); (b) the first (or production) storage array (106A); (c) the second (or first recovery) storage array (106B); and (d) the third (or second recovery) storage array (106C). The host device (104) and the first storage array (106A) may reside within the first (or production) site (102A), whereas the second storage array (106B) may reside within the second (or first recovery) site (102B), while the third storage array (106C) may reside within the third (or second recovery) site (102C).

Furthermore, in one embodiment of the invention, the host device (104) may operatively connect to the first storage array (106A) through the first (or intra-site) link (A). The first storage array (106A) may operatively connect to the second storage array (106B) through the third (or second inter-site) link (C). Meanwhile, the first storage array (106A) may also operatively connect to the third storage array (106C) through a fifth (or fourth inter-site) link (E). By way of example, the first, third, and fifth links (A, C, E) may, at least in part, be implemented using a fibre-channel connection (FICON) fabric, or any other medium that facilitates data transfer. The three-site multi-target mirroring configuration (112) is described in further detail below with respect to FIG. 1D.

While FIG. 1A shows a few non-limiting configurations of components, other system (100) configurations may be used without departing from the scope of the invention.

FIG. 1B shows a two-site mirroring configuration in accordance with one or more embodiments of the invention. The two-site mirroring configuration (108) may encompass operative connections between: (a) the host device (104) and the first storage array (106A) through the first link (A); and (b) the first storage array (106A) and the second storage array (106B) through the second link (B).

In one embodiment of the invention, the first link (A) may refer to a direct or indirect physical communication medium or conduit (e.g., cabling facilitating data transfer) operatively connecting the host device (104) and the first storage array (106A). Communications exchanged across the first link (A) may be directed, but are not limited to: data storage (or write) operations; data retrieval (or read) operations; data mirroring (or replication) operations management (e.g., mirroring source and target device pair configurations, etc.); and data snapshot operations management (e.g., snapshot source and target device pair configurations, etc.). Further, the aforementioned communications may employ, or conform to, an external management protocol. Generally, a management protocol may refer to any predetermined set of rules, routines, and/or definitions directed to enabling at least the afore-described communications. The external management protocol, accordingly, may refer to a management protocol that may at least invoke data mirroring and/or snapshot functionality non-native to the first and second storage arrays (106A, 106B).

In one embodiment of the invention, the second link (B) may refer to a direct or indirect physical communication medium or conduit (e.g., cabling facilitating data transfer) operatively connecting the first storage array (106A) and the second storage array (106B). Communications exchanged across the second link (B) may be directed, but are not limited to: remote data mirroring (or replication) operations. Further, the aforementioned communications may employ, or conform to, an internal mirroring protocol. Generally, a mirroring protocol may refer to any predetermined set of rules, routines, and/or definitions directed to replicating data across near or extended distances. The internal mirroring protocol, accordingly, may refer to an asynchronous mirroring protocol that may at least invoke data mirroring functionality native to the first and second storage arrays (106A, 106B). By way of an example, the internal mirroring protocol may be implemented as the Symmetrix Remote Data Facility Asynchronous (SRDF/A) protocol developed by Dell EMC of Hopkinton, Mass.

In one embodiment of the invention, the first storage array (106A) may include a first storage controller (120A). The first storage controller (120A) may represent management logic, which may be implemented using physical components (e.g., computer processor and memory), logical components (e.g., computer programs and processes), or a combination thereof. Further, the first storage controller (120A) may include functionality to: facilitate communications between the first storage array (106A) and one or more external entities (e.g., the host device (104), the second storage array (106B), and/or the third storage array (106C)); oversee operations pertinent to the first storage array (106A); and manage a first set of storage devices (122A-122N), as well as any data stored therein. One of ordinary skill will appreciate that the first storage controller (120A) may perform other functionalities without departing from the scope of the invention.

In one embodiment of the invention, the first storage array (106A) may further include a first set of storage devices (122A-122N). Each storage device (122A-122N) may encompass non-transitory computer readable storage media on which data may be stored in whole or in part, and temporarily or permanently. Further, each storage device (122A-122N) may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the first set of storage devices (122A-122N) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, at least with respect to the two-site mirroring configuration (108), one or more storage devices (e.g., Storage Device AA (122A)) of the first set of storage devices (122A-122N) may also be referred to as primary mirroring sources. A primary mirroring source may refer to a data mirroring (or replication) source device on and from which original (or production) data may reside and may be mirrored to a primary mirroring target (described below), respectively.

In one embodiment of the invention, the second storage array (106B) may include a second storage controller (120B). The second storage controller (120B) may represent management logic, which may be implemented using physical components (e.g., computer processor and memory), logical components (e.g., computer programs and processes), or a combination thereof. Further, the second storage controller (120B) may include functionality to: facilitate communications between the second storage array (106B) and one or more external entities (e.g., the first storage array (106A) and/or the third storage array (106C)); oversee operations pertinent to the second storage array (106B); and manage a second set of storage devices (124A-124N), as well as any data stored therein. One of ordinary skill will appreciate that the second storage controller (120B) may perform other functionalities without departing from the scope of the invention.

In one embodiment of the invention, the second storage array (106B) may further include a second set of storage devices (124A-124N). Each storage device (124A-124N) may encompass non-transitory computer readable storage media on which data may be stored in whole or in part, and temporarily or permanently. Further, each storage device (124A-124N) may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the second set of storage devices (124A-124N) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, at least with respect to the two-site mirroring configuration (108), one or more storage devices (e.g., Storage Device BA (124A)) of the second set of storage devices (124A-124N) may also be referred to as primary mirroring targets and/or primary snapshot sources. A primary mirroring target may refer to a data mirroring (or replication) target device to which original (or production) data may be mirrored from a primary mirroring source (described above), and on which a first-degree copy of original data may reside. A primary snapshot source, in turn, may refer to a data snapshot source device from which a snapshot of first-degree copy data may be near-instantaneously replicated to a snapshot target (described below). A snapshot may refer to a point-in-time image-based copy of data.

In one embodiment of the invention, at least with respect to the two-site mirroring configuration (108), one or more other storage devices (e.g., Storage Device BG (124G)) of the second set of storage devices (124A-124N) may also be referred to as primary snapshot targets. A primary snapshot target may refer to a data snapshot target device to which first-degree copy (or first recovery) data may be replicated from a snapshot source (described above), and on which a first-degree copy snapshot may reside.

In one embodiment of the invention, a given primary snapshot source (e.g., Storage Device BA (124A)) may operatively connect to a given primary snapshot target (e.g., Storage Device BG (124G)) through a sixth (or intra-array) link (F). The sixth link (F) may refer to a direct or indirect physical communication medium or conduit (e.g., cabling facilitating data transfer) operatively connecting a given primary snapshot source and a given primary snapshot target. Communications exchanged across the sixth link (F) may be directed, but are not limited to: data snapshot (or near-instantaneous replication) operations. Further, the aforementioned communications may employ, or conform to, an internal snapshot protocol. Generally, a snapshot protocol may refer to any predetermined set of rules, routines, and/or definitions directed to replicating data near-instantaneously across near distances. The internal snapshot protocol, accordingly, may refer to a snapshot protocol that may at least invoke data snapshot functionality native to the first and second storage arrays (106A, 106B). By way of an example, the internal snapshot protocol may be implemented as the Compatible Native Flash protocol developed by Dell EMC of Hopkinton, Mass.

While FIG. 1B shows a configuration of components, other two-site mirroring (108) configurations may be used without departing from the scope of the invention.

FIG. 1C shows a three-site single-target mirroring configuration in accordance with one or more embodiments of the invention. The three-site single-target mirroring configuration (110) may encompass operative connections between: (a) the host device (104) (not shown) and the first storage array (106A) (not shown) through the first link (A) (not shown) (described above) (see e.g., FIG. 1B); (b) the first storage array (106A) and the second storage array (106B) through a third link (C); and (c) the second storage array (106B) and the third storage array (106C) through the fourth link (D).

In one embodiment of the invention, the third link (C) may refer to a direct or indirect physical communication medium or conduit (e.g., cabling facilitating data transfer) operatively connecting the first storage array (106A) (not shown) and the second storage array (106B). Communications exchanged across the third link (C) may be directed, but are not limited to: remote data mirroring (or replication) operations. Further, the aforementioned communications may employ, or conform to, an external mirroring protocol. Generally, a mirroring protocol may refer to any predetermined set of rules, routines, and/or definitions directed to replicating data across near or extended distances. The external mirroring protocol, accordingly, may refer to a synchronous mirroring protocol that may at least invoke data mirroring functionality non-native to the first, second, and third storage arrays (106A, 106B, 106C). By way of an example, the external mirroring protocol may be implemented as the Compatible Peer protocol developed by Dell EMC of Hopkinton, Mass.

In one embodiment of the invention, the fourth link (D) may refer to a direct or indirect physical communication medium or conduit (e.g., cabling facilitating data transfer) operatively connecting the second storage array (106B) and the third storage array (106C). Communications exchanged across the fourth link (D) may be directed, but are not limited to: remote data mirroring (or replication) operations. Further, the aforementioned communications may employ, or conform to, an internal mirroring protocol. The internal mirroring protocol may refer to an asynchronous mirroring protocol that may at least invoke data mirroring functionality native to the first, second, and third storage arrays (106A, 106B, 106C). By way of an example, the internal mirroring protocol may be implemented as the Symmetrix Remote Data Facility Asynchronous (SRDF/A) protocol developed by Dell EMC of Hopkinton, Mass.

In one embodiment of the invention, at least with respect to the three-site single-target mirroring configuration (110), one or more storage devices (e.g., Storage Device BA (124A)) of the second set of storage devices (124A-124N) may also be referred to as primary mirroring targets (described above) (see e.g., FIG. 1B) and/or secondary mirroring sources. A secondary mirroring source may refer to a data mirroring (or replication) source device on and from which first-degree copy (or first recovery) data may reside and may be mirrored to a secondary mirroring target (described below), respectively.

In one embodiment of the invention, the third storage array (106C) may include a third storage controller (120C). The third storage controller (120B) may represent management logic, which may be implemented using physical components (e.g., computer processor and memory), logical components (e.g., computer programs and processes), or a combination thereof. Further, the third storage controller (120C) may include functionality to: facilitate communications between the third storage array (106C) and one or more external entities (e.g., the first storage array (106A) (see e.g., FIG. 1D) and/or the second storage array (106B)); oversee operations pertinent to the third storage array (106C); and manage a third set of storage devices (126A-126N), as well as any data stored therein. One of ordinary skill will appreciate that the third storage controller (120C) may perform other functionalities without departing from the scope of the invention.

In one embodiment of the invention, the third storage array (106C) may further include a third set of storage devices (126A-126N). Each storage device (126A-126N) may encompass non-transitory computer readable storage media on which data may be stored in whole or in part, and temporarily or permanently. Further, each storage device (126A-126N) may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the third set of storage devices (126A-126N) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, at least with respect to the three-site single-target mirroring configuration (110), one or more storage devices (e.g., Storage Device CA (126A)) of the third set of storage devices (126A-126N) may also be referred to as secondary mirroring targets and/or secondary snapshot sources. A secondary mirroring target may refer to a data mirroring (or replication) target device to which first-degree copy data may be mirrored from a secondary mirroring source (described above), and on which a second-degree copy of original data may reside. A secondary snapshot source, in turn, may refer to a data snapshot source device from which a snapshot of second-degree copy data may be near-instantaneously replicated to a secondary snapshot target (described below). A snapshot may refer to a point-in-time image-based copy of data.

In one embodiment of the invention, at least with respect to the three-site single-target mirroring configuration (110), one or more other storage devices (e.g., Storage Device CG (126G)) of the third set of storage devices (126A-126N) may also be referred to as secondary snapshot targets. A secondary snapshot target may refer to a data snapshot target device to which second-degree copy (or second recovery) data may be replicated from a secondary snapshot source (described above), and on which a second-degree copy snapshot may reside.

In one embodiment of the invention, a given secondary snapshot source (e.g., Storage Device CA (126A)) may operatively connect to a given secondary snapshot target (e.g., Storage Device CG (126G)) through the sixth (or intra-array) link (F). The sixth link (F) may refer to a direct or indirect physical communication medium or conduit (e.g., cabling facilitating data transfer) operatively connecting a given secondary snapshot source and a given secondary snapshot target. Communications exchanged across the sixth link (F) may be directed, but are not limited to: data snapshot (or near-instantaneous replication) operations. Further, the aforementioned communications may employ, or conform to, an internal snapshot protocol. The internal snapshot protocol may refer to a snapshot protocol that may at least invoke data snapshot functionality native to the first, second, and third storage arrays (106A, 106B, 106C). By way of an example, the internal snapshot protocol may be implemented as the Compatible Native Flash protocol developed by Dell EMC of Hopkinton, Mass.

While FIG. 1C shows a configuration of components, other three-site single-target mirroring (110) configurations may be used without departing from the scope of the invention.

FIG. 1D shows a three-site multi-target mirroring configuration in accordance with one or more embodiments of the invention. The three-site multi-target mirroring configuration (112) may encompass operative connections between: (a) the host device (104) (not shown) and the first storage array (106A) (not shown) through the first link (A) (not shown) (described above) (see e.g., FIG. 1B); (b) the first storage array (106A) and the second storage array (106B) through the third link (C) (described above) (see e.g., FIG. 1C); and (c) the first storage array (106A) and the third storage array (106C) through the fifth link (E).

In one embodiment of the invention, the fifth link (E) may refer to a direct or indirect physical communication medium or conduit (e.g., cabling facilitating data transfer) operatively connecting the first storage array (106A) (not shown) and the third storage array (106C). Communications exchanged across the fifth link (E) may be directed, but are not limited to: remote data mirroring (or replication) operations. Further, the aforementioned communications may employ, or conform to, an external mirroring protocol. Generally, a mirroring protocol may refer to any predetermined set of rules, routines, and/or definitions directed to replicating data across near or extended distances. The external mirroring protocol, accordingly, may refer to a asynchronous mirroring protocol that may at least invoke data mirroring functionality non-native to the first, second, and third storage arrays (106A, 106B, 106C). By way of an example, the external mirroring protocol may be implemented as the Remote Data Facility Asynchronous (RDF/A) protocol developed by Dell EMC of Hopkinton, Mass.

In one embodiment of the invention, at least with respect to the three-site multi-target mirroring configuration (112), one or more storage devices (e.g., Storage Device BA (124A)) of the second set of storage devices (124A-124N) may also be referred to as primary mirroring targets (described above) (see e.g., FIG. 1B) and/or secondary mirroring sources (described above) (see e.g., FIG. 1C).

In one embodiment of the invention, at least with respect to the three-site multi-target mirroring configuration (112), one or more storage devices (e.g., Storage Device CB (126B)) of the third set of storage devices (126A-126N) may also be referred to as primary mirroring targets and/or primary snapshot sources (described above) (see e.g., FIG. 1B).

In one embodiment of the invention, at least with respect to the three-site multi-target mirroring configuration (112), one or more other storage devices (e.g., Storage Device CG (126G)) of the third set of storage devices (126A-126N) may also be referred to as primary snapshot targets (described above) (see e.g., FIG. 1B).

In one embodiment of the invention, a given primary snapshot source (e.g., Storage Device CB (126B)) may operatively connect to a given primary snapshot target (e.g., Storage Device CG (126G)) through the sixth (or intra-array) link (F). The sixth link (F) may refer to a direct or indirect physical communication medium or conduit (e.g., cabling facilitating data transfer) operatively connecting a given primary snapshot source and a given primary snapshot target. Communications exchanged across the sixth link (F) may be directed, but are not limited to: data snapshot (or near-instantaneous replication) operations. Further, the aforementioned communications may employ, or conform to, an internal snapshot protocol. The internal snapshot protocol may refer to a snapshot protocol that may at least invoke data snapshot functionality native to the first, second, and third storage arrays (106A, 106B, 106C). By way of an example, the internal snapshot protocol may be implemented as the Compatible Native Flash protocol developed by Dell EMC of Hopkinton, Mass.

While FIG. 1D shows a configuration of components, other three-site multi-target mirroring (112) configurations may be used without departing from the scope of the invention.

In one or more above-described embodiments of the invention, data replicated and retained on the snapshot sources and targets (e.g., primary or secondary), on either the second storage array (106B) respective to two-site mirroring (108) or the third storage array (106C) respective to three-site single- and/or multi-target mirroring (110, 112), may reflect point-in-time consistent data. Data may be defined to be point-in-time consistent if all its interrelated components remain as they were at a specific point-in-time. Further, point-in-time data consistency on any given snapshot source may rely on a proper functionality and/or nominal performance of the internal mirroring protocol (described above).

In one or more other embodiments of the invention, the internal mirroring protocol, responsible for effecting data mirroring (or replication) across extended distances between the first and second storage arrays (106A, 106B) respective to two-site mirroring (108) or between the second and third storage arrays (106B, 106C) respective to three-site single- and multi-target mirroring (110, 112), may (on occasion) experience improper functionality and/or poor performance. Prior to the occurrence of such an event, the snapshot target may be disabled or deactivated, while the snapshot source maintains point-in-time data consistency. However, at the outset of issues with the internal mirroring protocol, thereby leading to the snapshot source becoming inconsistent respective to a specific point-in-time, the snapshot source may be disabled or deactivated, and the snapshot target (which had been previously disabled) may be enabled or activated. In activating the snapshot target, the snapshot target assumes the maintenance of consistent point-in-time data with respect to data retained on the production storage array (106A). Later, upon re-establishment of proper and/or nominal internal mirroring protocol functionality and/or performance, the snapshot target may be disabled or deactivated, while the snapshot source may be re-enabled or re-activated; and, accordingly, may reassume its function to maintain point-in-time data consistency.

FIG. 2 shows an exemplary computing system in accordance with one or more embodiments of the invention. The computing system (200) may include one or more computer processors (202), non-persistent storage (204) (e.g., volatile memory, such as random access memory (RAM), cache memory), persistent storage (206) (e.g., a hard disk, an optical drive such as a compact disk (CD) drive or digital versatile disk (DVD) drive, a flash memory, etc.), a communication interface (212) (e.g., Bluetooth interface, infrared interface, network interface, optical interface, etc.), input devices (210), output devices (208), and numerous other elements (not shown) and functionalities. Each of these components is described below.

In one embodiment of the invention, the computer processor(s) (202) may be an integrated circuit for processing instructions. For example, the computer processor(s) may be one or more cores or micro-cores of a central processing unit (CPU) and/or a graphics processing unit (GPU). The computing system (200) may also include one or more input devices (210), such as a touchscreen, keyboard, mouse, microphone, touchpad, electronic pen, or any other type of input device. Further, the communication interface (212) may include an integrated circuit for connecting the computing system (200) to a network (not shown) (e.g., a local area network (LAN), a wide area network (WAN) such as the Internet, mobile network, or any other type of network) and/or to another device, such as another computing device.

In one embodiment of the invention, the computing system (200) may include one or more output devices (208), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (202), non-persistent storage (204), and persistent storage (206). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A system for two-site mirroring, comprising:
a first site comprising a first storage device; and
a second site residing in a separate spatial or geographical location relative to the first site, the second site comprising:
a second storage device operatively connected to the first storage device through a first link; and
a third storage device operatively connected to the second storage device through a second link.

2. The system of claim 1,
wherein when the first link is operating normally:
the second storage device is active and maintains first point-in-time consistent data respective to data retained on the first storage device; and
the third storage device is inactive,
wherein when the first link is not operating normally:
the second storage device becomes inactive; and
the third storage device becomes active and maintains second point-in-time consistent data respective to the data retained on the first storage device.

3. The system of claim 1, wherein communications exchanged across the first link employ an internal mirroring protocol, wherein the internal mirroring protocol enables remote asynchronous data replication.

4. (canceled)

5. The system of claim 1, wherein communications exchanged across the second link employ an internal snapshot protocol, wherein the internal snapshot protocol enables near-instantaneously generated data replication.

6. (canceled)

7. The system of claim 1, wherein the first site further comprises a host device operatively connected to the first storage device through a third link.

8. The system of claim 7, wherein communications exchanged across the third link employ an external management protocol.

9. A system for three-site single-target mirroring, comprising:
a first site comprising a first storage device;
a second site residing in a separate spatial or geographical location relative to the first site, the second site comprising a second storage device operatively connected to the first storage device through a first link; and
a third site residing in a separate spatial or geographical location relative to the first and the second sites, the third site comprising:
a third storage device operatively connected to the second storage device through a second link; and
a fourth storage device operatively connected to the third storage device through a third link.

10. The system of claim 9,
wherein when the second link is operating normally:
the third storage device is active and maintains first point-in-time consistent data respective to data retained on the first storage device; and
the fourth storage device is inactive,
wherein when the second link is not operating normally:
the third storage device becomes inactive; and
the fourth storage device becomes active and maintains second point-in-time consistent data respective to the data retained on the first storage device.

11. The system of claim 9, wherein communications exchanged across the first link employ an external mirroring protocol, wherein the external mirroring protocol enables remote synchronous data replication.

12. (canceled)

13. The system of claim 9, wherein communications exchanged across the second link employ an internal mirroring protocol, wherein the internal mirroring protocol enables remote asynchronous data replication.

14. The system of claim 9, wherein communications exchanged across the third link employ an internal snapshot protocol, wherein the internal snapshot protocol enables near-instantaneously generated data replication.

15. The system of claim 9, wherein the first site further comprises a host device operatively connected to the first storage device through a fourth link.

16. A system for two-site multi-target mirroring, comprising:
a first site comprising a first storage device;
a second site residing in a separate spatial or geographical location relative to the first site, the second site comprising a second storage device operatively connected to the first storage device through a first link; and
a third site residing in a separate spatial or geographical location relative to the first and the second sites, the third site comprising:
a third storage device operatively connected to the first storage device through a second link; and
a fourth storage device operatively connected to the third storage device through a third link.

17. The system of claim 16,
wherein when the second link is operating normally:
the third storage device is active and maintains first point-in-time consistent data respective to data retained on the first storage device; and
the fourth storage device is inactive,
wherein when the second link is not operating normally:
the third storage device becomes inactive; and
the fourth storage device becomes active and maintains second point-in-time consistent data respective to the data retained on the first storage device.

18. The system of claim 16, wherein communications exchanged across the first link employs an external mirroring protocol, wherein communications exchanged across the second link employs the external mirroring protocol, wherein communications exchanged across the third link employs an internal snapshot protocol.

19. The system of claim 18, wherein the external mirroring protocol enables remote synchronous data replication, wherein the internal snapshot protocol enables near-instantaneously generated data replication.

20. The system of claim 16, wherein the first site further comprises a host device operatively connected to the first storage device through a fourth link.

21. The system of claim 1, wherein the second link uses an asynchronous mirroring protocol to invoke data mirroring functionality native to the first and second storage devices.

22. The system of claim 1, wherein the second link uses an asynchronous mirroring protocol to invoke data mirroring functionality native to the first and third storage devices.

23. The system of claim 1, wherein the first storage device is operatively connected to a host device through a link, wherein the link uses a synchronous mirroring protocol to invoke data mirroring or snapshot functionality non-native to the first and second storage devices.
